(19) United States
(12) Patent Application Publication
(10) Pub. No.: US 2026/0249504 A1
(43) Pub. Date: Aug. 27, 2026

(54) Blade Holder for Machine for Processing Webs of Material

(71) Applicant: BW Converting S.p.A., Barga (Lucca) (IT)

(72) Inventor: Massimo Gabrielli, Barga (Lucca) (IT)

(21) Appl. No.: 19/454,506

(22) Filed: Jan. 21, 2026

Related U.S. Application Data
(60) Provisional application No. 63/761,590, filed on Feb. 21, 2025.

(51) Int. Cl. B26D 7/26; B26D 1/00; B26D 1/01

(52) U.S. Cl. CPC B26D 7/2614; B26D 1/015; B26D 2001/006

(57) ABSTRACT

A blade holder for holding a blade is mounted to a machine. A seat of the blade holder receives the blade. A clamp has a pivot connection to the blade holder. An engagement portion of the clamp is movable about the pivot between an engaged position and a disengaged position. An actuation portion of the clamp is movable about the pivot between an actuation position and a non-actuation position. The engagement portion secures the blade in the seat when the blade is received in the seat, the engagement portion is in the engaged position, and the actuation portion is in the actuation position. The engagement portion releases the blade from the seat when the engagement portion is in the disengaged position and the actuation portion is in the non-actuation position. An actuator moves the actuation portion from the non-actuation position to the actuation position.

### RELATED APPLICATION DATA

This application claims priority benefit to U.S. provisional app. Ser. No. 63/761,590, filed Feb. 21, 2025, the disclosure of which is incorporated by reference herein.

### BACKGROUND

This disclosure is directed to a blade holder for a blade used on a machine for processing a web of material in a converting line. The blade holder may be installed on a support beam in a stationary application or may be used on a roll in a rotary application. The blader holder may be used to hold a perforating blade or a cutting blade. The blade holder may be used to hold a helical blade or a straight blade. In one particular application, the blade holder may be used on a stationary knife in an interfolder apparatus. However, by way of example and not in any limiting sense, the blade holder may be used to hold a cutting blade on a knife roll in an interfolder machine, a cutting blade on a knife roll in a sheeter machine, or a perforating blade in a perforator of a rewinder.

### DESCRIPTION OF THE DRAWINGS

FIG. 1 shows a front view of a typical interfolder machine with a stationary knife and a knife roll, where the exemplary blade holder is used on the stationary knife.

FIG. 2A is a perspective view of a stationary knife and the knife roll.

FIG. 2B is a perspective view of the stationary knife.

FIG. 3 is a perspective section view of the stationary knife of FIG. 2B showing additional detail of the blade holder of the stationary knife.

FIG. 4 is another perspective section view of the of the blade holder of the stationary knife of FIG. 2B.

FIG. 5 is side section view of the of the blade holder of the stationary knife of FIG. 2B.

FIG. 6 is a side view of the exemplary blade holder in an alternate application comprising a cutting roll.

FIG. 7 is a perspective view of the exemplary blade holder in an alternative application comprising a cutting roll.

FIG. 8 is a perspective section view of the blade holder of FIG. 7.

FIG. 9 is a side section view of the blade holder taken along line 9-9 of FIG. 7.

FIG. 10 is a side section view of the blade holder taken along line 10-10 of FIG. 7.

FIG. 11 is a side section view of the blade holder taken along line 11-11 of FIG. 7.

### DETAILED DESCRIPTION

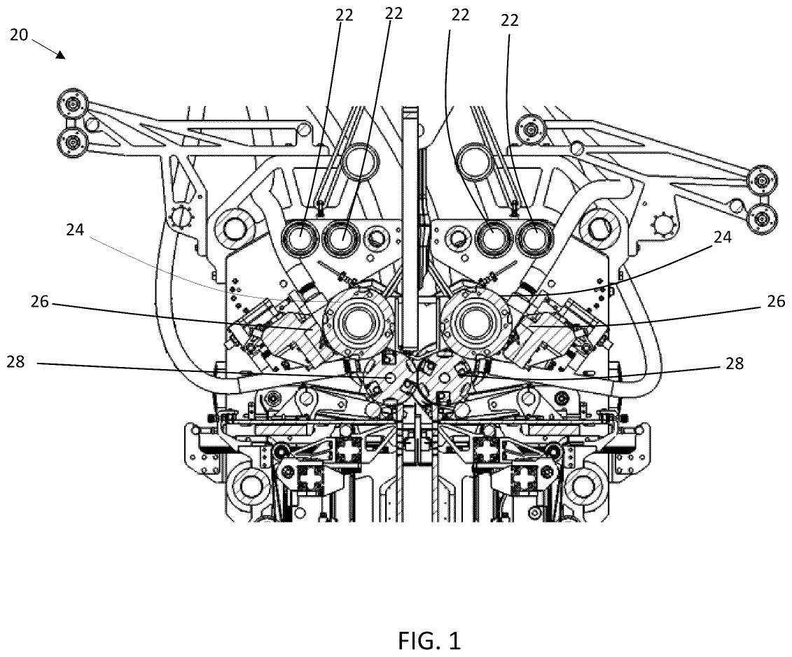

Referring to FIG. 1, the interfolder machine 20 includes a plurality of draw rolls 22 for feeding one or more webs of material to a knife roll 24 and a stationary knife 26 where the web of material is cut into sheets. After being cut, the sheets move on to corresponding folding rolls 28. The folding rolls 28 receive the cut sheets of web material from the knife roll 24 and the stationary knife 26, and form the sheets into a stack downstream of the nip formed by the folding rolls 28.

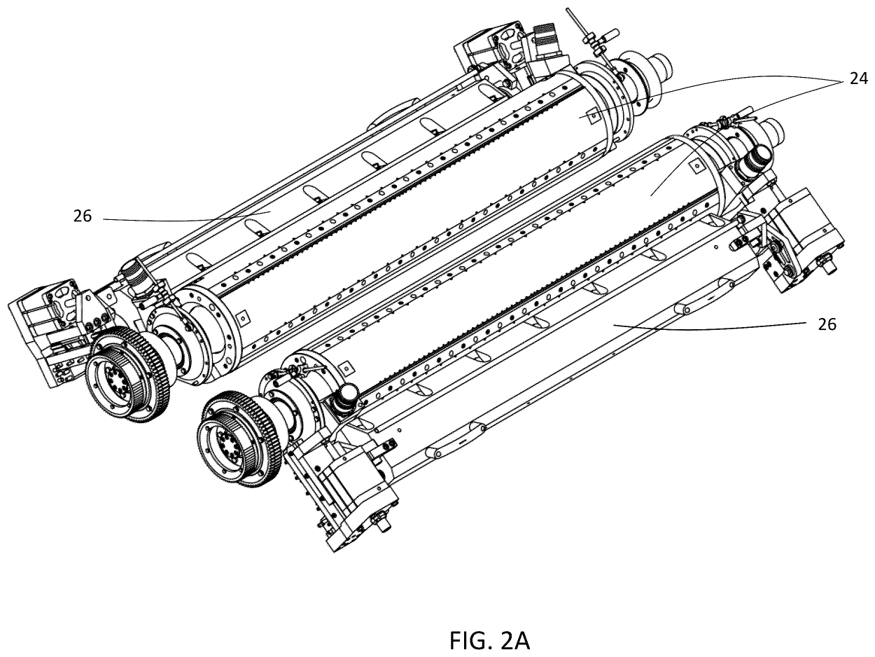

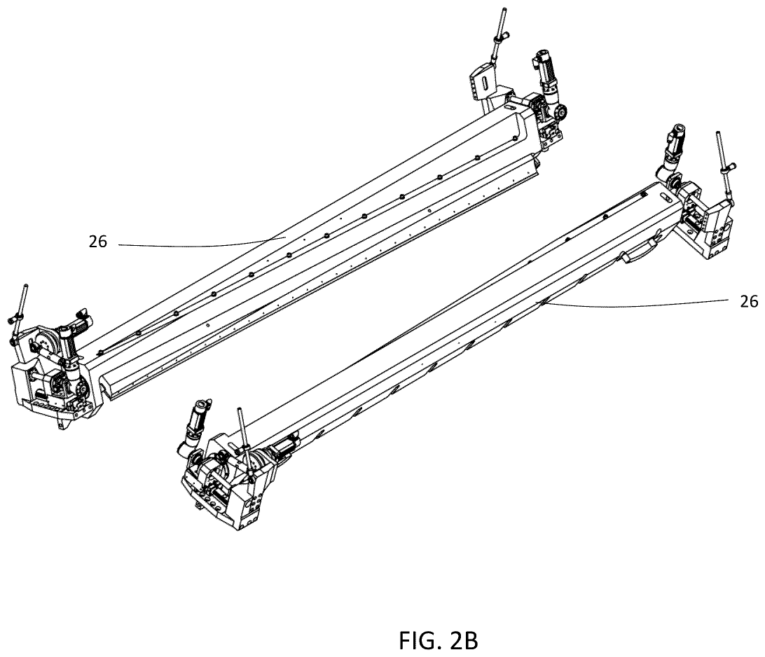

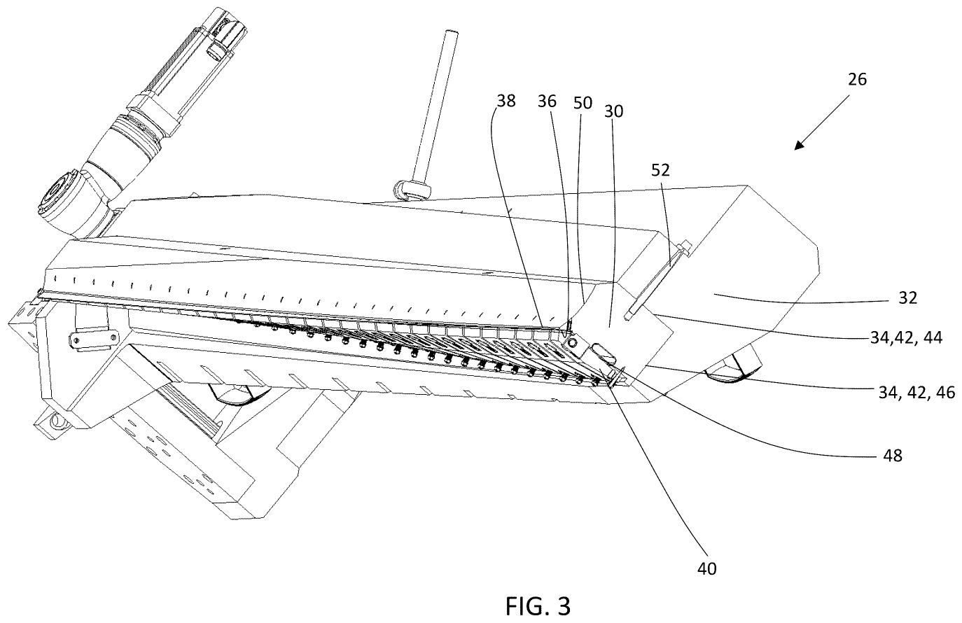

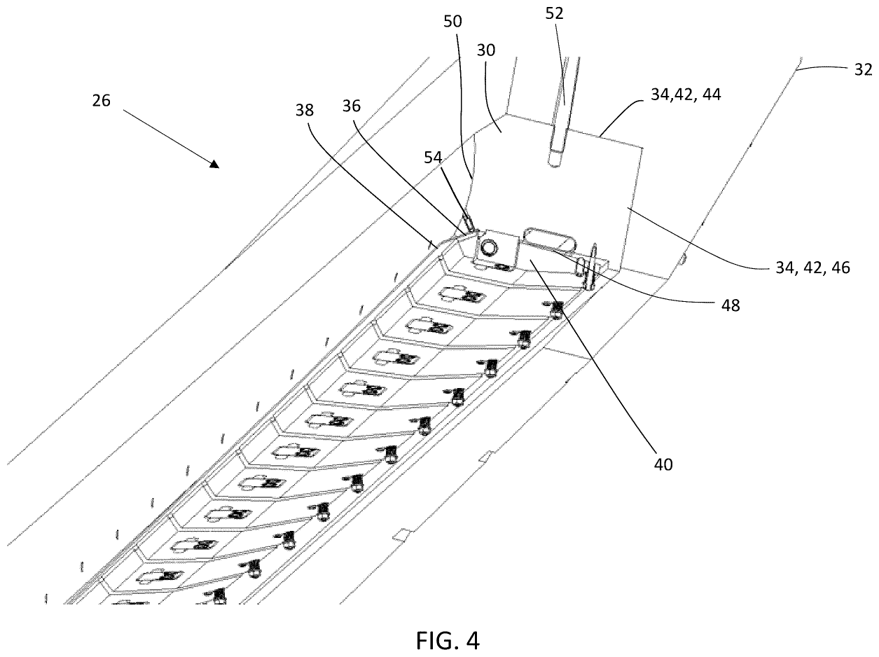

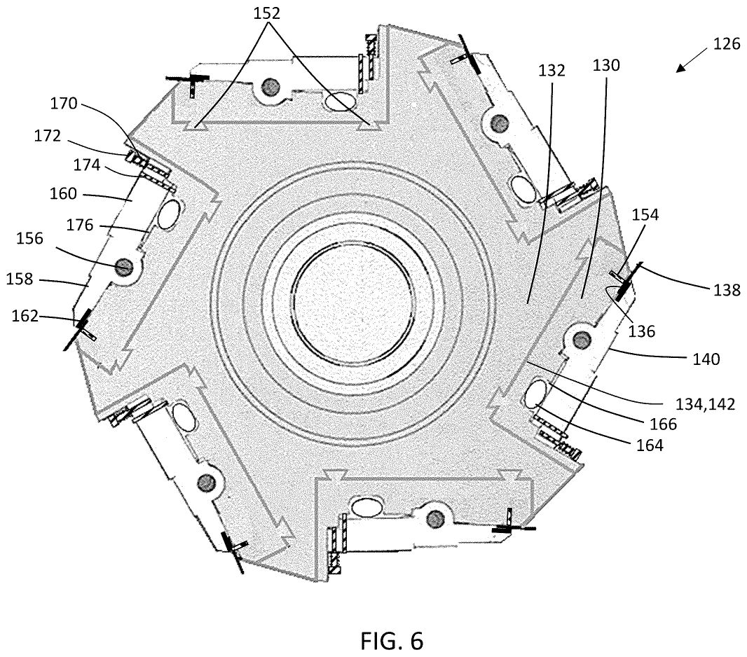

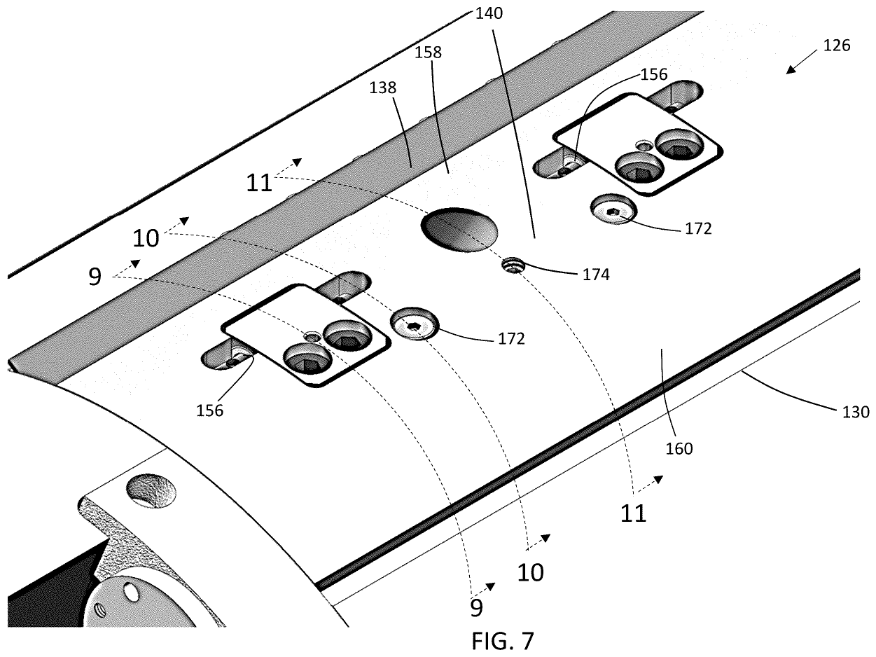

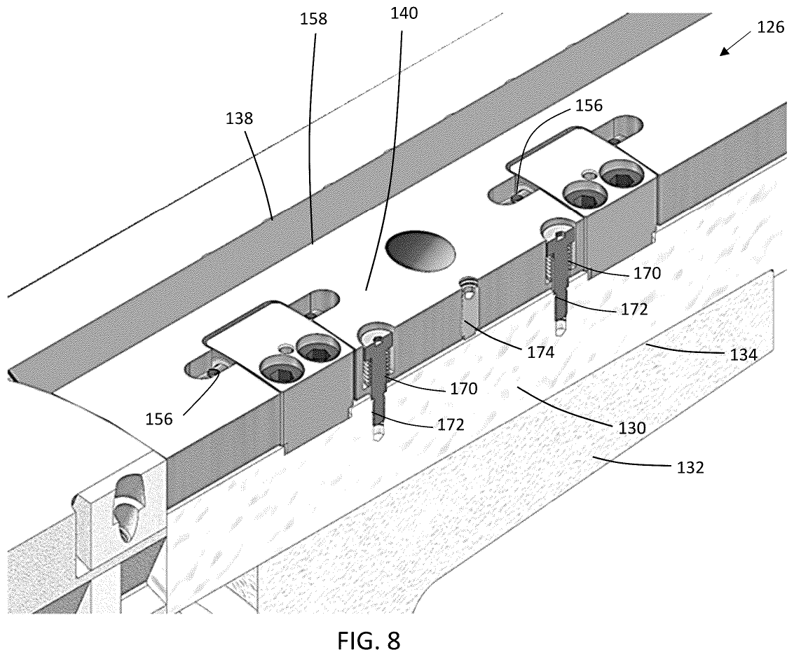

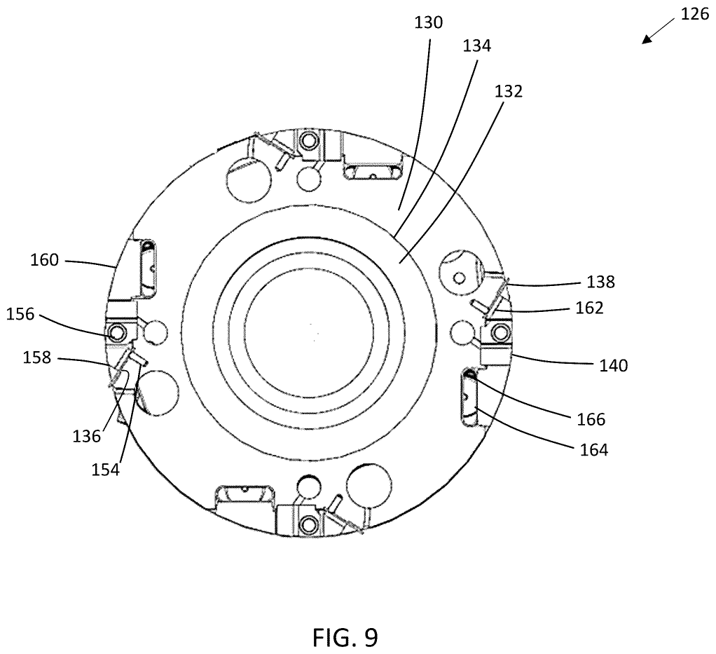

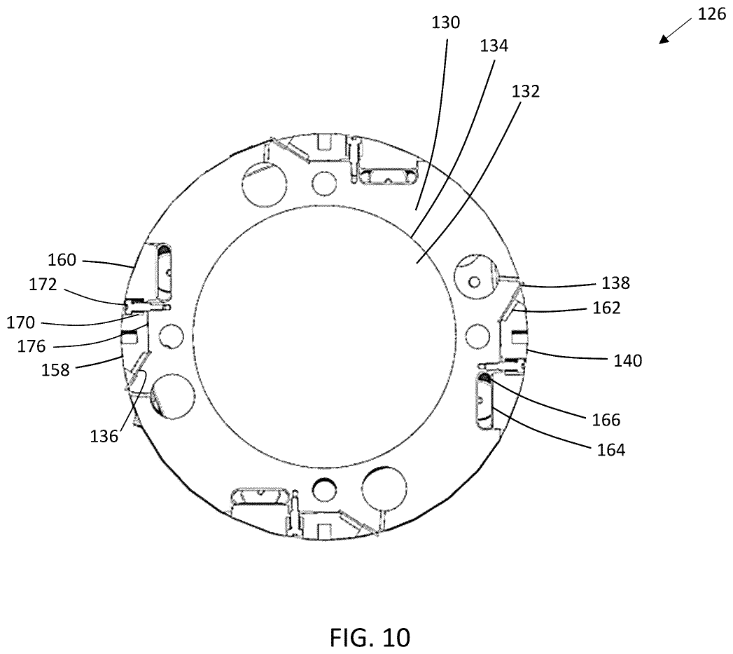

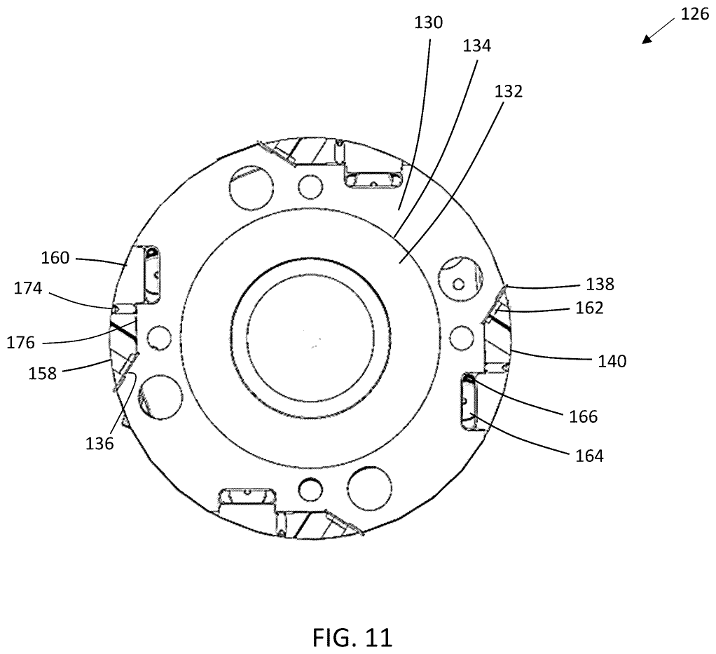

By example and not in any limiting sense, to illustrate the various aspects of the exemplary blade holder, the blade holder 30 referred to in FIGS. 2A, 2B and 3-5 is described in the context of the stationary knife 26 of the interfolder machine 20, and the blade holder 130 referred to in FIG. 6 is described in the context of a roll 126. Referring to FIG. 2A, 2B and 3-5, the blade holder 30 has a mounting surface 34 adapted and configured to allow the blade holder to be mounted to the support beam 32 of the stationary knife 26. The blade holder 30 has a seat 36 adapted and configured to receive a blade 38 for cutting the web into sheets between the knife roll 24 and the stationary knife 26. The blade 38 is secured in the seat 36 with a clamp 40. The blade holder 30 is generally rectangular in cross section and is received in a shoulder 42 formed in the support beam 32 of the stationary knife 26. More in particular, as shown in the drawings, the blade holder 30 is generally square in shape with the mounting surface 34 comprising first and second coterminous sides 44,46, the clamp 40 and the seat 36 being arranged along a third side 48, and a fourth side 50 that is coterminous with the first and third sides 44,48. However, the blade holder may have another shape as needed depending upon the application. For instance, FIG. 6 shows a roll 126 of a machine. The blade holder 130 may be mounted to a body 132 of the roll 126 with mounting surfaces 134 that cooperate with shoulders 142 formed in the body of the roll. In the alternative, as shown in FIGS. 7-11, the blade holder 130 may be integral with or monolithically formed with body 132 of the roll 126. Accordingly, the blade holder 130 may be an annular shaped or a cylindrical member mounted on or formed with the body 132 of the roll 126. The body 132 of the roll 126 may comprise a seat 136 for a blade 138 that is held on the seat with a clamp 140. Conventional, mechanical fasteners 52, for example, as shown in FIG. 3, and/or dovetail 152 and/or “T” shaped slots, for example, as shown in FIG. 6, may be used to mount the blade holder 30,130 on the support beam 32 or on the body of the roll 132.

The seat 36,136 extends in a direction along a length of the blade holder 30,130. In the exemplary stationary blade 26 used in an interfolder application, the seat 36 has a length that is substantially the same as the blade holder 30 so as to accommodate a blade 38 having a length that is substantially the same as the blade holder for the width of web to be processed in the interfolder machine 20. However, as mentioned before the blade holder 30,130 described herein may be used in other types of machines. Depending upon the application and the machine, the seat 36,136 may have the same or different size along the length dimension of the blade holder 30,130. For instance, in a rotary die cut application, the blade that is received in the seat may be sized for a particular processing job, for instance, sized for a particular width of web or a cut dimension to be applied to a web. Accordingly, the blade may occupy the entire dimension of the seat or a portion of the seat. Likewise, the seat may extend the entire length of the blade holder or partially along the length blade holder. The blade 38,138 may be used to cut the web or perforate the web depending upon the application and the machine. While the blade shown in the drawings is helical and thus the shape of the seat is helical, the blade may be straight and the shape of the seat may be generally straight.

The seat 36,136 may be positioned on the blade holder 30,130 in a manner to secure the blade 38,138 in a position to cut the web processed in the machine. For instance, in the exemplary interfolder 20, the seat 36 may be positioned on the blade holder 30 and the blade holder 30 positioned on the support beam 32 of the stationary knife 26 to cut the web against the knife roll 24. For instance, in the exemplary roll application, the seat 136 may be positioned on the blade holder 130 and the blade holder 130 positioned on the body 132 of the roll to cut the web against an anvil roll. Accordingly, the seat 36,136 may support the blade 38,138 so the blade is exposed and projects outward from the seat in a direction (i.e., angle and distance) to cut or perforate the web processed in the machine. The seat 36,136 may comprise one or more a spring loaded detents 54,154 for locating the blade 38,138 in the seat.

The clamp 40,140 may have a pivot connection 56,156 to the blade holder 30,130. The clamp 40,140 may have an engagement portion 58,158 on one side pivot connection and an actuation portion 60,160 on the other side of the pivot connection. The engagement portion 58,158 may be movable about the pivot connection 56,156 between an engaged position and a disengaged position. The actuation portion 60,160 is correspondingly movable about the pivot connection 56,156 between an actuation position and a non-actuation position. The engaged position of the engagement portion corresponds to the actuation position of the actuation portion. The disengaged position of the engagement portion corresponds to the non-actuation position of the actuation portion. The engagement portion 58,158 is configured to secure the blade 38,138 in the seat 36,136 when the blade is received in the seat, the engagement portion is in the engaged position, and the actuation portion 60,160 is in the actuation position. The engagement portion 58,158 is configured to release the blade 38,138 from the seat 36,136 when the engagement portion is in the disengaged position and the actuation portion is in the non-actuation position. The engagement portion 58,158 may comprise an elastomeric material 62,162 for instance, a polyurethane or rubber material, between the blade 38,138 and the engagement portion 58,158. The elastomeric material 62,162 may be bonded to the clamp. The elastomeric material 62,162 may provide friction to hold the blade securely in the seat 36,136. The elastomeric material may provide noise abatement by dampening the impulse force between the blade 38,138 and an anvil. One or more clamps 40,140 may be provided on the blade holder 30,130. Thus, the clamp 40,140 may be one of a plurality of like clamps of the blade holder 30,130. The plurality of like clamps of the blade holder may extend along a substantial portion of, or the majority of, the length of the seat which may correspond to a substantial portion of, or the majority of, the length blade holder.

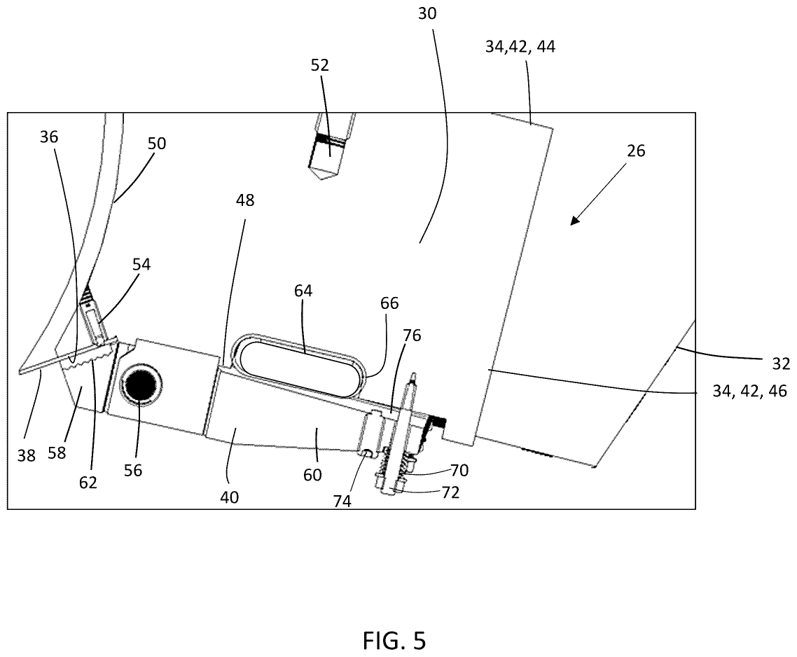

The blade holder 30,130 further includes an actuator 64,164 configured to move the actuation portion 60,160 from the non-actuation position to the actuation position. The actuator 64,164 may comprise an inflatable bladder that is disposed in a recess 66,166 of the blade holder. There may be an actuator 64,164 for each clamp 40,140 in the plurality of clamps, or there may an actuator that actuates one, several or all of the clamps of the blade holder. In one aspect, the inflatable bladder or tube comprises a flexible material, such as rubber, synthetic fibers, nitrile or the like, that may be filled and evacuated with an appropriate fluid, such as air. The actuator 64,164 may be housed the recess 66,166 formed in the blade holder 30,130 and acts on the actuation portion 60,160 of the clamp 40,140 to move the clamp about pivot connection 56,156. For instance, referring to FIG. 5, the actuator 64 inflates and pivots the clamp 40 clockwise about the pivot connection 56. In so doing, the engagement portion 58 pivots clockwise to the engagement position to secure blade 38 in the seat 36. When the actuator 64,164 is de-actuated, the actuator deflates. To provide positive movement of the actuation portion 60,160 of the clamp 40,140 to the non-actuation position, a biasing member 70,170 may be provided. The biasing member 70,170 may be mounted on the actuation portion 60,160. The biasing member 70,170 is configured to move the actuation portion 60,160 from the actuation position to the non-actuation position. The biasing member 70,170 may comprise a spring held in position on the actuation portion with a mechanical fastener 72,172. As shown in the drawings, the mechanical fastener 72,172 may comprise a shoulder bolt with the biasing member 70,170 comprising a coil spring in compression. The coil spring 70,170 may be held against the head of shoulder bolt 72,172 and an exposed surface of the actuation portion 60,160 of the clamp 40.140. As the actuator deflates, the coil spring may expand and move the actuation portion 60,160 of the clamp 40,140 to the non-actuation position (counter clockwise in FIG. 5). A stop 74,174 may also be provided to set the non-actuation position. The stop 74,174 may be mounted on the actuation portion 60,160. The stop 74,174 may be positionable on the actuation portion 60,160 to set the non-actuation position. The stop 74,174 may comprise a set screw. For instance, when the actuator deflates, the coil spring 70,170 may expand and slide over the smooth shank of the shoulder bolt 72,172 and move the actuation portion 60,160 of the clamp 40,140 to the non-actuation position, which motion may be limited by the set screw 74,174 bearing against a surface of the blade holder 30,130. There may be a clearance space 76,176 between the actuation portion 60,160 of the clamp 40,140 and the blade holder 30,130 to allow adjustment of the set screw 74,174 against the blade holder 30,130. A biasing member 70,170 and/or a stop 74,174 may be provided on each clamp 40,140 in the plurality of clamps.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention.

Thus, various modifications and changes may be made thereunto without departing from the broader spirit and scope of the invention as set forth in the claims and that the invention is intended to cover all modifications and equivalents within the scope of the following claims.

What is claimed:

1. A blade holder for holding a blade of a machine of a converting line, the machine being configured to process a web of material, the blade holder comprising:
a mounting surface adapted and configured for mounting the blade holder to the machine,
a seat adapted and configured to receive the blade for processing the web on the machine;
a clamp, the clamp having a pivot connection to the blade holder, the clamp having an engagement portion on one side of the pivot connection and an actuation portion on an other side of the pivot connection, the engagement portion being movable about the pivot connection between an engaged position and a disengaged position, the actuation portion being movable about the pivot connection between an actuation position and a non-actuation position, the engaged position of the engagement portion corresponding to the actuation position of the actuation portion, the disengaged position of the engagement portion corresponding to the non-actuation position of the actuation portion, the engagement portion being configured to secure the blade in the seat when the blade is received in the seat, the engagement portion is in the engaged position, and the actuation portion is in the actuation position, the engagement portion being configured to release the blade from the seat when the engagement portion is in the disengaged position and the actuation portion is in the non-actuation position;
an actuator configured to move the actuation portion from the non-actuation position to the actuation position;
a stop mounted on the actuation portion, the stop being positionable, the stop being configured to set the non-actuation position; and
a biasing member mounted on the actuation portion, the biasing member being configured to move the actuation portion from the actuation position to the non-actuation position.

2. The blade holder of claim 1 wherein the seat extends in a direction along a length of the blade holder.

3. The blade holder of claim 1 wherein the mounting surface extends in a direction along a length of the blade holder.

4. The blade holder of claim 1 wherein the blade holder is generally rectangular in cross section with the mounting surface comprising first and second coterminous sides, the clamp and the seat being arranged along a third side, and a fourth side that is coterminous with the third side.

5. The blade holder of claim 1 wherein the seat is configured for one of a helical blade and a straight blade.

6. The blade holder of claim 1 wherein the seat is configured for receiving at least one of a perforating blade and a cutting blade.

7. The blade holder of claim 1 wherein the clamp is one a plurality of like clamps of the blade holder.

8. The blade holder of claim 7 wherein the plurality of like clamps of the blade holder extends along a length of the blade holder.

9. The blade holder of claim 7 wherein the actuator is configured to move the actuation portion of each of the clamps of the plurality of like clamps from the non-actuation position to the actuation position.

10. The blade holder of claim 9 wherein the actuator comprises an inflatable bladder.

11. A machine of a converting line, the machine comprising:
at least one of a roll and a support beam for processing a web in the machine of the converting line, the at least one of the roll and the support beam comprising a blade holder, the blade holder comprising:
a mounting surface adapted and configured for mounting the blade holder to the at least one of the roll and the support beam,
a seat adapted and configured to receive a blade for processing the web on the machine;
a clamp, the clamp having a pivot connection to the blade holder, the clamp having an engagement portion on one side of the pivot connection and an actuation portion on an other side of the pivot connection, the engagement portion being movable about the pivot connection between an engaged position and a disengaged position, the actuation portion being movable about the pivot connection between an actuation position and a non-actuation position, the engaged position of the engagement portion corresponding to the actuation position of the actuation portion, the disengaged position of the engagement portion corresponding to the non-actuation position of the actuation portion, the engagement portion being configured to secure the blade in the seat when the blade is received in the seat, the engagement portion is in the engaged position, and the actuation portion is in the actuation position, the engagement portion being configured to release the blade from the seat when the engagement portion is in the disengaged position and the actuation portion is in the non-actuation position;
an actuator configured to move the actuation portion from the non-actuation position to the actuation position;
a stop mounted on the actuation portion, the stop being positionable, the stop being configured to set the non-actuation position; and
a biasing member mounted on the actuation portion, the biasing member being configured to move the actuation portion from the actuation position to the non-actuation position.

12. The machine of claim 11 wherein the seat is configured for one of a helical blade and a straight blade.

13. The machine of claim 11 wherein the seat is configured for receiving at least one of a perforating blade and a cutting blade.

14. The machine of claim 11 wherein the clamp is one a plurality of like clamps of the blade holder.

15. The machine of claim 14 wherein the plurality of like clamps of the blade holder extends along a length of the blade holder.

16. The machine of claim 14 wherein the actuator is configured to move the actuation portion of each of the clamps of the plurality of like clamps from the non-actuation position to the actuation position.

17. The machine of claim 16 wherein the actuator comprises an inflatable bladder.

18. The machine of claim 11 wherein the seat extends in a direction along a length of the blade holder.

19. The machine of claim 11 wherein the mounting surface extends in a direction along a length of the blade holder.

20. The machine of claim 11 wherein the blade holder is generally rectangular in cross section with the mounting surface comprising first and second coterminous sides, the clamp and the seat being arranged along a third side, and a fourth side that is coterminous with the third side.
